(19) United States
(12) Patent Application Publication
(10) Pub. No.: US 2014/0179213 A1
(43) Pub. Date: Jun. 26, 2014

(54) CONTROL DOOR FOR AIR CONDITIONER

(71) Applicants: HYUNDAI MOTOR COMPANY, Seoul (KR); KIA MOTORS CORPORATION, Seoul (KR)

(72) Inventors: Seung Hoon Moon, Seoul (KR); Myung Hoe Kim, Seoul (KR); Seung Wook Kim, Seoul (KR); Jae Min Yang, Suwon (KR)

(73) Assignees: KIA MOTORS CORPORATION, Seoul (KR); HYUNDAI MOTOR COMPANY, Seoul (KR)

(21) Appl. No.: 13/859,217

(22) Filed: Apr. 9, 2013

(30) Foreign Application Priority Data
Dec. 26, 2012 (KR) 10-2012-0153737

(51) Int. Cl. B60H 1/34

(52) U.S. Cl. CPC B60H 1/34
USPC 454/152

(57) ABSTRACT

Disclosed herein is a control door for an air conditioner. The control door includes a door panel that includes a plurality of discharge apertures, and is located around a vent of a housing of the air conditioner and is configured to slide to close and open the vent via the discharge apertures. A take-up shaft is disposed on each of opposite sides of the vent of the housing of the air conditioner, each of opposite ends of the door panel is wound onto the take-up shaft. The control door further includes a drive part configured to transmit a rotating force to the take-up shaft, to allow the door panel to slide around the vent of the housing of the air conditioner.

### CROSS-REFERENCE TO RELATED APPLICATION

This application claims under 35 U.S.C. §119(a) the benefit of Korean Patent Application No. 10-2012-0153737 filed on Dec. 26, 2012 the entire contents of which are incorporated herein by reference.

### BACKGROUND OF THE INVENTION

1. Field of the Invention

The present invention relates to a mode control door for an air conditioner formed as a substantially thin plate and configured to slide around a vent to implement an air conditioning mode.

2. Description of the Related Art

A conventional air conditioner for a vehicle includes a heater core and an evaporator core installed in a housing of the air conditioner, a plurality of internal flow passageways formed to enable suction of interior air or exterior air, conditioned air having a temperature controlled by a temperature control door created and selectively discharged through a plurality of vents, thus implementing a face mode, a floor mode, a defrost mode, a rear-seat console mode, etc. of the air conditioner.

However, the modes are implemented, respectively, by the selective discharge through a plurality of apertures formed in the housing of the air conditioner. Approximately 7 to 8 modes may be implemented by the air conditioner. Therefore, the conventional air conditioner includes a plurality of rotary-type mode control doors installed in a vent side of the housing, wherein the respective doors are independently controlled, thus operating the plurality of modes.

However, in the conventional air conditioner the plurality of doors required to implement these modes increases a manufacturing cost, and noise increases due to a collision between the housing and the doors when air passes through.

A conventional air conditioner includes a mode door with a single thin plate member formed by connecting a first door configured to close at least two vents to a second door configured to close one vent via a bridge, and in addition, a receiving portion disposed in an air conditioner casing to extend in a sliding direction of the thin plate member, thus receiving an end of the thin plate member. Through such a configuration, the size of the air conditioner need not increase to operate the thin plate member, and in addition, it may be possible to open or close a plurality of vents using a single mode door. Since the single thin plate member having an improved structure is used, the entire structure of the mode door has a reduced number of parts, a weight, and a manufacturing cost, and durability may increase. Moreover, the use of the single thin plate (e.g., film) member prevents odor from being emitted due to a build-up of fungus.

However, in the above configuration, a gear unit configured to slide the mode door is located on a central portion of the door, and both ends of the door are free ends, thus, when air is discharged through the vent, the door comes into close contact with the housing and thus the required sliding force to operate the door increases. Further, since both ends of the door are free ends, the ends of the door frequently collide with an inner wall of the housing and cause a rattling noise.

The foregoing is intended merely to aid in the understanding of the background of the present invention, and is not intended to mean that the present invention falls within the purview of the related art that is already known to those skilled in the art.

### SUMMARY

Accordingly, the present invention provides a control door for an air conditioner, which may maintain a space between a sliding type mode door of the air conditioner and an inner wall of a housing, thus reducing a required operating force as well as noise.

Specifically, the present invention provides a control door for an air conditioner, including a door panel made of a material having substantial flexibility and elasticity, and including a plurality of discharge apertures, wherein the door panel may be disposed around a vent of a housing of the air conditioner and may be configured to slide to close the vent and to open the vent via the discharge apertures; a take-up shaft disposed on each of opposite sides of the vent of the housing of the air conditioner, wherein each of opposite ends of the door panel may be wound onto the take-up shaft; and a drive part configured to transmit a rotating force to the take-up shaft, to allow the door panel to slide around the vent of the housing of the air conditioner. The door panel may be made of plastic and may have a shape of a substantially thin plate.

In addition, mesh gears may be circumferentially formed on each of opposite side ends of the take-up shaft, and mesh apertures may be formed in predetermined positions on each of opposite side ends of the door panel to allow the mesh gears to pass therethrough. A drive gear may be disposed on an exterior of the mesh gears of the take-up shaft, and may engage with the drive part, thus receiving the rotating force transmitted from the drive part.

The take-up shaft may include a pair of shafts, a first shaft disposed on a first side and a second shaft disposed on a second side being rotated in the same direction to allow the door panel to be wound onto the second side when the door panel is unwound from the first side. The door panel may be installed in the housing of the air conditioner to be adjacent to the vent. Furthermore, the door panel may be configured to slide while being pulled by the take-up shaft.

As apparent from the above description, the present invention may maintain a space between a sliding type mode door of the air conditioner and an inner wall of a housing, thus reducing a required operating force as well as noise. Further the size of a door drive part may be decreased, thus allowing the size of the air conditioner housing to decrease, and increasing a distance from a dashboard, thus increasing safety performance in the event of a collision.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary view showing a control door for an air conditioner, according to an exemplary embodiment of the present invention;

FIG. 2 is an exemplary view showing parts of the control door for the air conditioner of FIG. 1 according to an exemplary embodiment of the present invention; and

FIG. 3 is an exemplary sectional view showing the control door for the air conditioner of FIG. 1 according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, a control door for an air conditioner according to an exemplary embodiment of the present invention will be described with reference to the accompanying drawings.

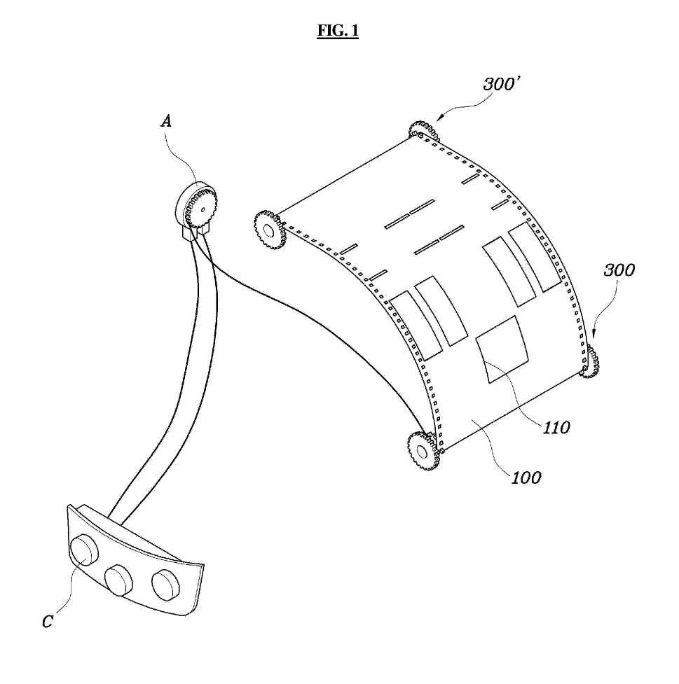

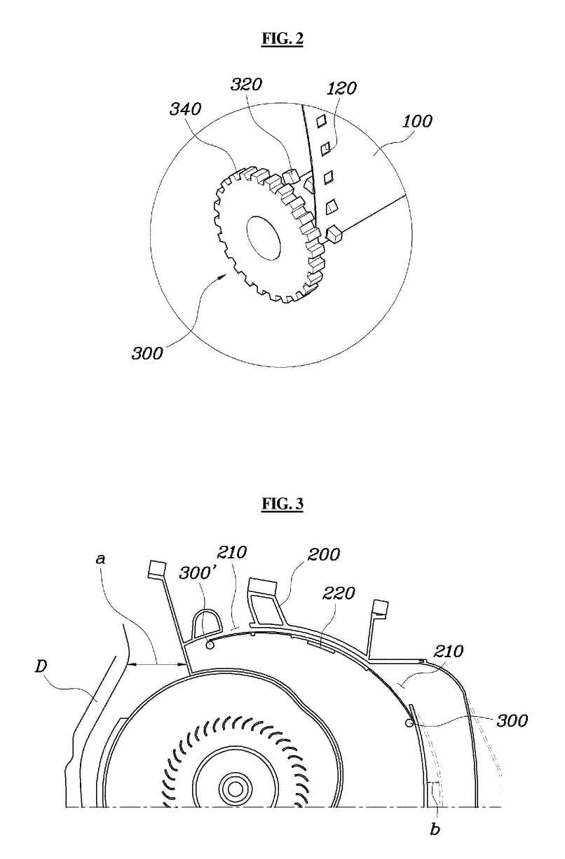

FIG. 1 is an exemplary view showing a control door for an air conditioner, according to an exemplary embodiment of the present invention, FIG. 2 is an exemplary view showing parts of the control door for the air conditioner of FIG. 1, and FIG. 3 is an exemplary sectional view showing the control door for the air conditioner of FIG. 1.

The control door for the air conditioner according to the present invention may include a door panel 100 and a plurality of take-up shafts 300. The door panel 100 may be made of a material having substantial flexibility and elasticity, and a plurality of discharge apertures 110 formed on the door panel 100. The door panel 100 may be disposed around a vent 210 of a housing 200 of the air conditioner and may be configured to slide to close the vent 210 and to open the vent 210 via the discharge apertures 110. The take-up shafts 300 may be disposed on opposite sides of the vent 210 of the housing 200 of the air conditioner, and opposite ends of the door panel 100 may be wound onto the take-up shafts 300, respectively.

In other words, the door panel 100 of the present invention may be a plate-shaped sliding panel, disposed around the vent 210 through which air discharged from the air conditioner housing 200 to an interior of a vehicle flows, and may be configured to slide into a position to open and close the vent 210. The housing 200 may include a plurality of vents 210 to allow the interior of the vehicle to communicate with different ducts depending on their positions, thus realizing a face mode, a floor mode and a defrost mode of the air conditioner.

Further, the plurality of discharge apertures 110 may be formed on the door panel 100 to selectively open and close the plurality of vents 210 in response to the sliding of the door panel 100, thus implementing various modes simultaneously and selectively. Thus, a maximum of 7 modes may be implemented.

Moreover, according to the present invention, the opposite ends of the door panel 100 may be wound onto or unwound from the take-up shafts 300, thus requiring a smaller space, and the door panel 100 may come into close contact with (e.g., may abut) the inner wall of the housing 200, thus eliminating a sensation of a stiff sliding operation. In other words, the take-up shafts 300 may be disposed on the opposite sides of the vent 210 of the air conditioner housing 200, to allow the opposite ends of the door panel 100 to be wound onto the take-up shafts 300, respectively.

Specifically, as shown in the drawings, a drive part A may be configured to receive an operating force from a controller of the interior functions of the vehicle, and may be configured to transmit the operating force to the take-up shafts 300 in the form of a rotating force, thus allowing the door panel 100 to slide around the vent 210 of the air conditioner housing 200. Various embodiments concerning the above-mentioned operation have been proposed. For example, the transmission of the rotating force by wiring, a chain or the like may be possible.

Furthermore, the door panel 100 may be made of plastic and may have a shape of a substantially thin plate. Therefore, the door panel 100 may have substantial flexibility to be wound onto the take-up shafts 300, and may also have substantial elasticity to be unwound therefrom.

Further, mesh gears 320 may be circumferentially formed on opposite side ends of each take-up shaft 300, and mesh apertures 120 may be formed in predetermined positions on opposite side ends of the door panel 100 to allow the mesh gears 320 to pass therethrough. Therefore, when the door panel 100 is wound or unwound, a mutual meshing structure may be achieved, thus allowing the upper take-up shaft 300′ and the lower take-up shaft 300 to be operated in conjunction with each other.

Additionally, a drive gear 340 may be disposed on an exterior of the mesh gears 320 of the take-up shaft 300, and may be configured to engage with the drive part A to receive the rotating force transmitted from the drive part A.

Moreover, as shown in the drawings, the take-up shaft 300 may include a plurality of shafts at upper and lower positions of the door panel 100. The take-up shaft 300 disposed on one side and the take-up shaft 300′ disposed on the other side may be rotated in the same direction thus, the door panel 100 may be wound on the other side when the door panel 100 is unwound from one side. In other words, the door panel 100 may be wound on a second side when the door panel 100 is unwound from a first side, wherein a first take-up shaft 300 is disposed on the first side and a second take-up shaft 300′ is disposed on the second side of the door panel 100.

Through such a process, the door panel 100 may be installed in the housing 200 of the air conditioner to be adjacent to the vent 210. The door panel 100 may be configured to slide while being pulled by the take-up shafts 300.

Further, as the air is discharged through the vent 210, the door panel 100 may come into close contact with (e.g., abut) the inner wall of the housing 200, thus reducing a change in operating sensation when the controller C is operated. In other words, the door panel 100 may be pulled substantially tautly, thus, even when air conditioning wind pressure pushes on the door panel 100, the door panel 100 may be spaced apart from the inner wall of the housing 200 by a predetermined distance. Furthermore, a rattling noise generated due to a collision between the door panel 100 and the inner wall of the housing 200 when the vehicle is driven on a substantially rough road or the like (e.g., a road having bumps) may be reduced.

Moreover, FIG. 3 is an exemplary view showing the control door for the air conditioner of FIG. 1. Referring to the drawing, the control door of the present invention may be installed to limit the door panel 100 to a position between at least two take-up shafts 300 and 300′, thus preventing the door panel 100 from passing over the take-up shafts 300 and 300′ in an upward or downward direction. Therefore, unlike the related art, the present invention may eliminate space of the apparatus, thus reducing a front interval a and a rear interval b of the air conditioner housing 200. Further, as the front interval a of the housing 200 is reduced, the housing 200 may be spaced apart from a dashboard D, to increase pedestrian protection in the event of a vehicle collision.

As described above, the present invention provides a control door for an air conditioner, which may maintains a space between a sliding type mode door of the air conditioner and an inner wall of a housing, thus reducing a required operating force as well as noise.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A control door for an air conditioner, comprising:
a door panel including a plurality of discharge apertures, is disposed around a vent of a housing of the air conditioner and is configured to slide to close the vent and to open the vent via the discharge apertures; and
a take-up shaft disposed on each of opposite sides of the vent of the housing of the air conditioner, wherein each of opposite ends of the door panel are wound onto the take-up shaft.

2. The control door as set forth in claim 1, further comprising:
a drive part configured to transmit a rotating force to the take-up shaft, to allow the door panel to slide around the vent of the housing of the air conditioner.

3. The control door as set forth in claim 1, wherein the door panel is made of plastic and has a shape of a substantially thin plate.

4. The control door as set forth in claim 1, further comprising:
a plurality of mesh gears circumferentially formed on each of opposite side ends of the take-up shaft; and
a plurality of mesh aperture formed in predetermined positions on each of opposite side ends of the door panel to allow the mesh gears pass therethrough.

5. The control door as set forth in claim 4, further comprising:
a drive gear disposed on an exterior of the mesh gears of the take-up shaft, and configured to engage with the drive part to receive the rotating force transmitted from the drive part.

6. The control door as set forth in claim 1, wherein the take-up shaft includes:
a plurality of shafts, wherein a first shaft is disposed on a first side and a second shaft is disposed on a second side and the shafts are configured to be rotated in the same direction to cause the door panel to be unwound from the first side, when the door panel is wound onto the second side.

7. The control door as set forth in claim 1, wherein the door panel is installed in the housing of the air conditioner to be adjacent to the vent.

8. The control door as set forth in claim 1, wherein the door panel is configured to slide and simultaneously to be pulled by the take-up shaft.
